(19) United States
(12) Patent Application Publication
(10) Pub. No.: US 2011/0261893 A1
(43) Pub. Date: Oct. 27, 2011

(54) WIRELESS COMMUNICATION APPARATUS AND WIRELESS COMMUNICATION METHOD

(75) Inventor: Taku Nakayama, Yokohama-shi (JP)

(73) Assignee: KYOCERA CORPORATION, KYOTO-SHI, KYOTO (JP)

(21) Appl. No.: 13/001,194

(22) PCT Filed: Jun. 25, 2009
(86) PCT No.: PCT/JP2009/061655

§ 371 Date: Mar. 22, 2011

(30) Foreign Application Priority Data
Jun. 27, 2008 (JP) 2008-169577

(51) Int. Cl. H04B 7/02

(52) U.S. Cl. 375/267

(57) ABSTRACT

Provided is a wireless communication apparatus which prevents deterioration of a communication characteristics because of a transmission weight of a highest common factor and enhances the communication characteristics of feedback MIMO. A wireless communication apparatus having a plurality of antennas includes a reception unit for receiving signals of channels in a predetermined frequency band from another wireless communication apparatus and obtaining channel state information of the channels, a channel state information calculation unit for calculating a weighted average of the channel state information as representative channel state information of the predetermined frequency band overall based on power of the channel state information, a transmission weight selection unit for selecting a transmission weight based on the representative channel state information, and a transmission unit for transmitting identification information of the transmission weight to the another wireless communication apparatus.

### CROSS REFERENCE TO RELATED APPLICATION

This application claims priority to and the benefit of Japanese Patent Application No. 2008-169577 (filed on Jun. 27, 2008), the entire contents of which are incorporated herein by reference.

### TECHNICAL FIELD

The present invention relates to a wireless communication apparatus and a wireless communication method.

### BACKGROUND ART

In recent years, wireless communication systems have used a plurality of antennas for transmission and reception of signals in order to increase communication capacity and to improve communication quality. Such transmission and reception scheme using a plurality of antennas is called MIMO (Multi-Input Multi-Output). In particular, a scheme that a reception terminal feedbacks information related to CSI (Channel State Information: propagation path information) to a transmission terminal is called Closed-Loop MIMO or feedback MIMO, which further improves communication characteristics of MIMO.

The reception terminal can measure CSIₖ for a k-th subcarrier (channel) as shown in Formula 1 based on a relationship between a specific reference signal (xᵢ) transmitted from the transmission terminal at predetermined intervals and a reception signal (y_{j,i}) of the reception terminal. In Formula 1, TxAnt and RxAnt respectively represent the number of antennas of the transmission terminal and the number of antennas of the reception terminal, whereas CSIₖ represents complex matrix having a dimension of RxAnt×TxAnt. In many cases, the reference signals are inserted in different subcarriers for each transmission antenna in fact, such that the reception terminal can separate reception signals. However, for a simple description, it is assumed here that reception signals and reference signals of all subcarriers are obtained separately by respective antennas.

$${CSI}_{k} = [ \begin{matrix}\frac{{y}_{0 , 0}}{{x}_{0}} & \frac{{y}_{0 , 1}}{{x}_{1}} & … & \frac{{y}_{0 , TxAnt - 1}}{{x}_{TxAnt - 1}} \\ \frac{{y}_{1 , 0}}{{x}_{0}} & \frac{{y}_{1 , 1}}{{x}_{1}} & & \frac{{y}_{1 , TxAnt - 1}}{{x}_{TxAnt - 1 }} \\ ⋮ & & ⋱ & ⋮ \\ \frac{{y}_{RxAnt - 1 , 0}}{{x}_{0}} & \frac{{y}_{RxAnt - 1 , 1}}{{x}_{1}} & … & \frac{{y}_{RxAnt - 1 , TxAnt - 1}}{{x}_{TxAnt - 1}}\end{matrix} ]$$

As for feedback MIMO, the communication characteristic of MIMO is more improved, as the information of the CSI fed back from the reception terminal to the transmission terminal is more detailed. However, an amount of communication data is more increased as the information of the CSI fed back from the reception terminal is more detailed, resulting in tightening the wireless communication capacity of the system. In order to address such a problem, it has been performed that the transmission terminal and the reception terminal commonly have information of transmission weight and the reception terminal feedbacks only index information (identification information) of the transmission weight corresponding to the CSI to the transmission terminal (that is, the reception terminal notifies the transmission terminal of an index number of transmission weight to be used only), which significantly reduces feedback information. In addition, applying a single transmission weight to a plurality of subcarriers collectively can reduce an index itself of the transmission weight to be fed back, enabling further reduction in the feedback information.

For example, as for UMB (Ultra Mobile Broadband, see Non-Patent Document 1, for example) and E-UTRA (LTE) (Evolved UMTS Terrestrial Radio Access, Long Term Evolution, see Non-Patent Document 2, for example), which are of 3.9 generation mobile communication systems (hereinafter, referred to as “3.9G”), the information of the transmission weight is shared as PM (Precoding Matrix) by the transmission terminal and the reception terminal. A plurality of PMs is defined correspondingly to the number of antennas and the like. The reception terminal selects a suitable PM according to the CSI and provides the transmission terminal with PMI (Precoding Matrix Index), which is an identification number of the PM, as feedback. When receiving PMI from the reception terminal, the transmission terminal controls the transmission weight of the plurality of antennas by using the PM identified by the PMI.

In UMB, for example, a frequency band used for communications is divided into eight subbands, and each of the subbands is divided into eight tiles, each of which is divided into sixteen subcarriers, as shown in FIG. 5. In order to select PM commonly applicable to the plurality of subcarriers, the reception terminal calculates an average value of the CSI (CSI_{Ave}) in the subband and the tile as a unit by using Formula 2. Here, N_{CSI} represents the number of subcarriers in the subband, and is 128(8×16) in the subband as the unit and 16 in the tile as the unit. When obtaining the average value of the CSI, the reception terminal selects a PM optimum to the average value of the CSI and provides the transmission terminal with the PMI corresponding to the PM as feedback.

$${CSI}_{Ave} = \frac{1}{{N}_{CSI}} {\sum }_{i = 0}^{{N}_{CSI} - 1} {CSI}_{i} = \frac{1}{{N}_{CSI}} ( {\sum }_{i = 0}^{{N}_{CSI} - 1} Re ( {CSI}_{i} ) + j {\sum }_{i = 0}^{{N}_{CSI} - 1} Im ( {CSI}_{i} ) ) \qquad [ Formula 2 ]$$

FIG. 6 shows changes of the frequency usage efficiency [bps/Hz] of the feedback MIMO when averaging of the CSI necessary for selection of the PMI is performed in the subband and in the tile as the unit and also when there is no control of the transmission weight by selection of the PMI. As shown in FIG. 6, under the same SNR (Signal to Noise Ratio) of the transmission signal, the communication characteristic is improved by control of the transmission weight. It is also shown that the communication characteristic is further improved when PMI is selected in a smaller unit (that is, not in the subband but in the tile, as the unit).

### RELATED ART DOCUMENTS

### Non-Patent Documents

Non-Patent Document 1: “Physical Layer for Ultra Mobile Broadband (UMB) Air Interface Specification (C.S0084-001-0 v1.0)”, 3GPP2, April 2007
Non-Patent Document 2: “Multiplexing and channel coding (3GPP TS36.212)”, 3GPP, May 2008

### SUMMARY OF INVENTION

### Technical Problem

As set forth above, according to a conventional method, the reception terminal selects a transmission weight index (PMI) to feedback to the transmission terminal, based simply on an average value of the CSI of subcarriers regardless of the communication quality of each subcarrier (channel) in a range to apply a common transmission weight (PM) (hereinafter, referred to as a “transmission weight application range), as shown in FIG. 7. Therefore, a transmission weight of the greatest common factor is selected, which is not optimum to any subcarrier. Such transmission weight of the greatest common factor causes a problem that phases of corresponding plurality of subcarriers rotate and cancel signals on a complex plane, leading to deterioration of the communication characteristics of MIMO using the transmission weight. Especially when the wireless communication quality changes significantly in each frequency in such as a multipath fading environment, it is expected that the wireless communication quality differs greatly in each of the 128/16 subcarriers included in each subband/tile.

An object of the present invention in consideration of the above problems is to provide a wireless communication apparatus and a wireless communication method which prevent deterioration of the communication characteristics by the transmission weight of the greatest common factor and enhance the communication characteristics of the feedback MIMO.

### Solution to Problem

In order to solve the above problems, a wireless communication apparatus having a plurality of antennas according to the present invention includes:

a reception unit for receiving signals of channels in a predetermined frequency band from another wireless communication apparatus and obtaining channel state information of the channels;

a channel state information calculation unit for calculating a weighted average of the channel state information as representative channel state information of the predetermined frequency band overall, based on power of the channel state information;

a transmission weight selection unit for selecting a transmission weight based on the representative channel state information; and

a transmission unit for transmitting identification information of the transmission weight to the another wireless communication apparatus.

In order to solve the above problems, a wireless communication apparatus having a plurality of antennas according to the present invention includes:

a reception unit for receiving signals of channels in a predetermined frequency band from another wireless communication apparatus and obtaining channel state information of the channels;

a channel state information calculation unit for calculating a weighted average of the channel state information as representative channel state information of the predetermined frequency band overall, based on amplitude of the channel state information;

a transmission weight selection unit for selecting a transmission weight based on the representative channel state information; and

a transmission unit for transmitting identification information of the transmission weight to the another wireless communication apparatus.

It is preferred that the transmission weight selection unit stores a corresponding relation between the channel state information and the transmission weight and selects the transmission weight stored corresponding to the representative channel state information.

In order to solve the above problems, a wireless communication method of a wireless communication apparatus having a plurality of antennas according to the present invention includes the steps of:

receiving signals of channels in a predetermined frequency band from another wireless communication apparatus and obtaining channel state information of the channels;

calculating a weighted average of the channel state information as representative channel state information of the predetermined frequency band overall, based on power of the channel state information;

selecting a transmission weight based on the representative channel state information; and

transmitting identification information of the transmission weight to the another wireless communication apparatus.

In order to solve the above problems, a wireless communication method of a wireless communication apparatus having a plurality of antennas according to the present invention includes the steps of:

receiving signals of channels in a predetermined frequency band from another wireless communication apparatus and obtaining channel state information of the channels;

calculating a weighted average of the channel state information as representative channel state information of the predetermined frequency band overall, based on amplitude of the channel state information;

selecting a transmission weight based on the representative channel state information; and

transmitting identification information of the transmission weight to the another wireless communication apparatus.

It is preferred, at the step of selecting the transmission weight, to select the transmission weight corresponding to the representative channel state information based on a corresponding relation between the channel state information and the transmission weight stored in advance.

### Effect of the Invention

According to the present invention, the transmission weight is not obtained by simply calculating an average CSI of subcarriers in a transmission weight application range, but by selecting a transmission weight based on the weighted average according to power of the CSI of the subcarriers in the transmission weight application range. Therefore, it is possible to improve the communication characteristics of feedback MIMO by reducing an influence by the subcarrier with limited channel capacity as a propagation path, reducing deterioration of accuracy of the CSI caused by a phenomenon that phases are reversed and cancel each other, and selecting a transmission weight having a strong influence on the subcarrier region with sufficient power.

In addition, the present invention utilizes a characteristic (diversity effect) which, because of the nature of error correction such as convolutional coding (CC) and convolutional turbo coding (CTC) applied to 3.9G, error correction is more effective on data series having distinctive good quality parts and poor quality parts than on data series of basically equal quality overall, under a condition with uniform average power.

### BRIEF DESCRIPTION OF DRAWINGS

FIG. 1 is a diagram illustrating a schematic constitution of a communication network which a communication terminal according to one embodiment of the present invention can use;

FIG. 2 is a diagram illustrating a constitution of the communication terminal according to one embodiment of the present invention;

FIG. 3 is a functional block diagram illustrating a schematic constitution of a CSI calculation unit shown in FIG. 2;

FIG. 4 is a flowchart of operation of the communication terminal according to one embodiment of the present invention;

FIG. 5 is a diagram illustrating an example of units of dividing a frequency band;

FIG. 6 is a diagram illustrating changes in frequency usage efficiency by transmission weight control; and

FIG. 7 is a flowchart of operation of a conventional communication terminal.

### DESCRIPTION OF EMBODIMENTS

Embodiments of the present invention will be described with reference to the accompanying drawings.

FIG. 1 shows a diagram illustrating a schematic constitution of a communication network which a communication terminal 1 according to one embodiment of the present invention can use. In FIG. 1, the communication terminal 1 performs communication with a base station 2 by MIMO using a plurality of antennas. The communication terminal 1 obtains CSI of each subcarrier from a reference signal transmitted by the base station 2. After performing a predetermined processing on the CSI, the communication terminal 1 selects a transmission weight (PM) which the base station 2 should use, and feedbacks a transmission weight index corresponding to the transmission weight to the base station 2. The base station 2 selects a transmission weight corresponding to the transmission weight index and controls feedback MIMO.

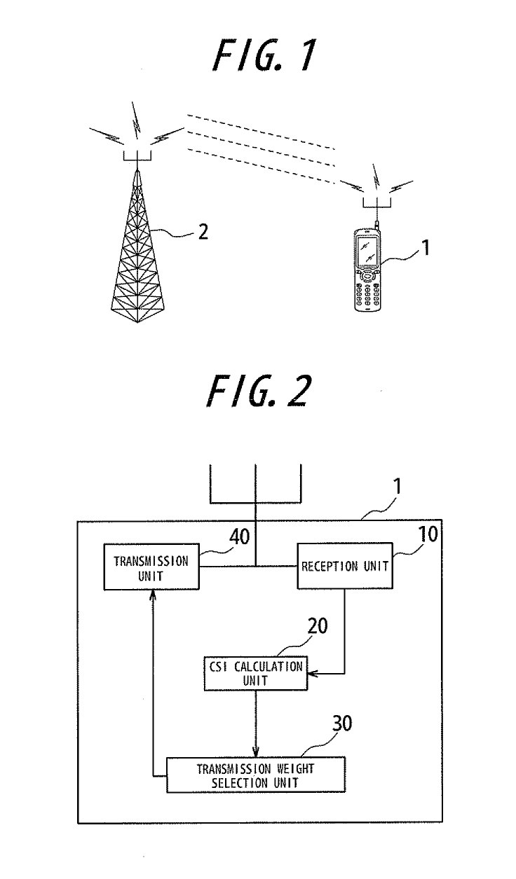

FIG. 2 is a diagram illustrating a constitution of the communication terminal 1 according to one embodiment of the present invention. Here, the communication terminal 1 may be, for example, a mobile phone, a laptop computer or a PDA (mobile information terminal) having a communication interface for MIMO. The communication terminal 1 has a reception unit 10 for receiving signals from the base station 2 and obtaining the CSI of subcarriers, a CSI calculation unit (channel state information calculation unit) 20 for obtaining information of CSI from the reception unit 10 and performing a predetermined calculation in association with the CSI, a transmission weight selection unit 30 for selecting a transmission weight index of a transmission weight to feedback to the base station 2 based on a result of calculation by the CSI calculation unit 20, and a transmission unit 40 for transmitting the transmission weight index, selected by the transmission weight selection unit 30, together with communication data and the like to the base station 2.

The reception unit 10 and the transmission unit 40 may be interface devices corresponding to the feedback MIMO. The reception unit 10 and the transmission unit 40 may have normal functions required for wireless communications, such as modulation/demodulation of a signal necessary for transmission and reception of a wireless signal, error correction decode/encode, PS/SP conversion, channel estimation and the like. The CSI calculation unit 20 and the transmission weight selection unit 30 may be any suitable processors such as a CPU (Central Processing Unit), and each function of the CSI calculation unit 20 and the transmission weight selection unit 30 may be configured by a software executed on the processor or a processor exclusive for processing of each function (for example, DSP (Digital Signal Processor)).

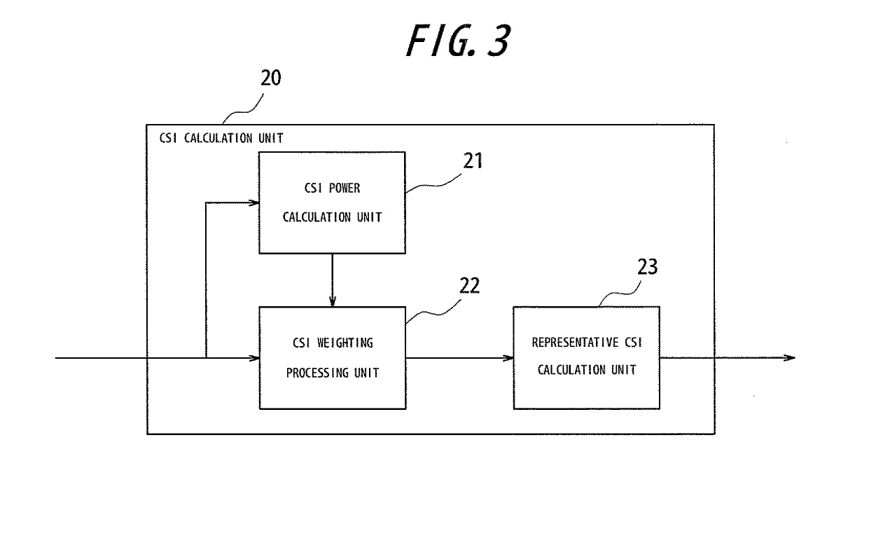

FIG. 3 is a functional block diagram illustrating a schematic constitution of the CSI calculation unit 20 shown in FIG. 2. The CSI calculation unit 20 has a CSI power calculation unit 21 for calculating power of each CSI in the transmission weight application range, a CSI weighting processing unit 22 for performing weighting processing on each CSI in the transmission weight application range based on a result of calculation by the CSI power calculation unit 21, and a representative CSI calculation unit 23 for calculating CSI power weighted in the weighting processing by the CSI weighting processing unit 22.

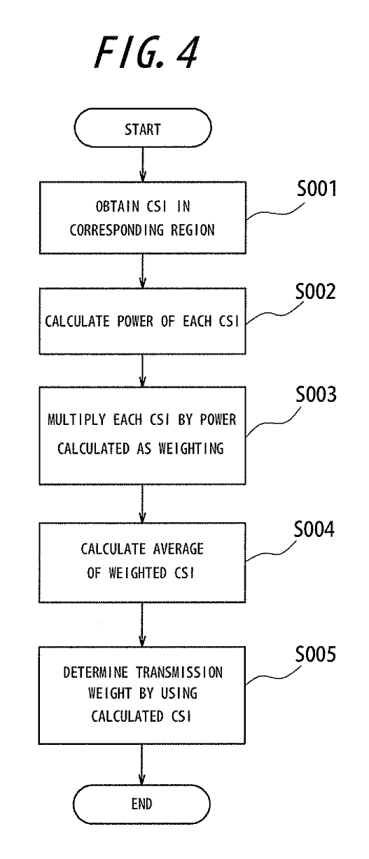

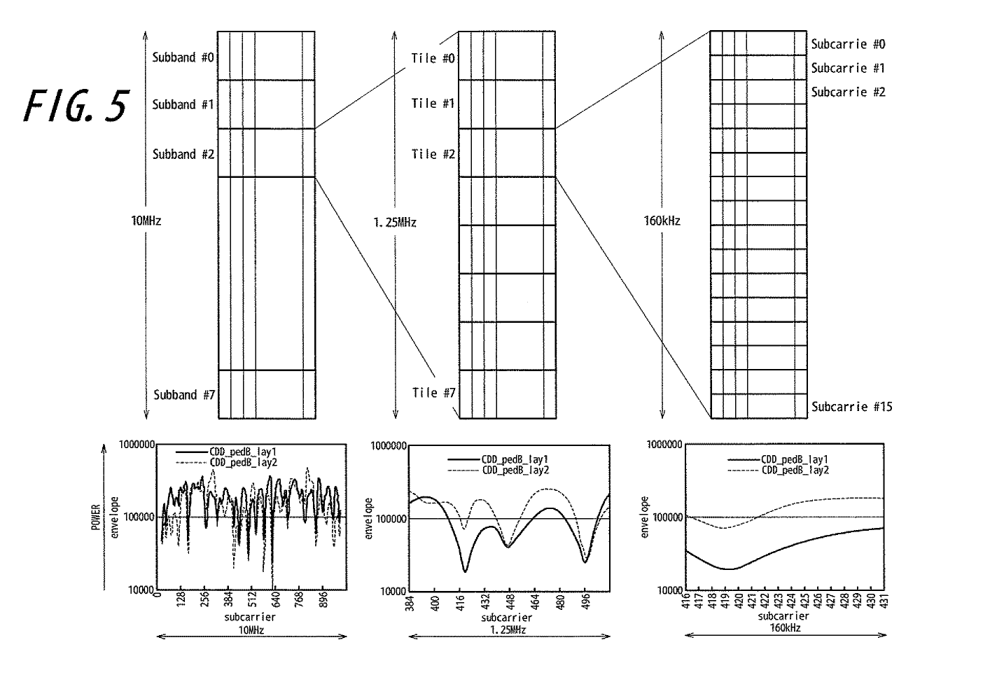

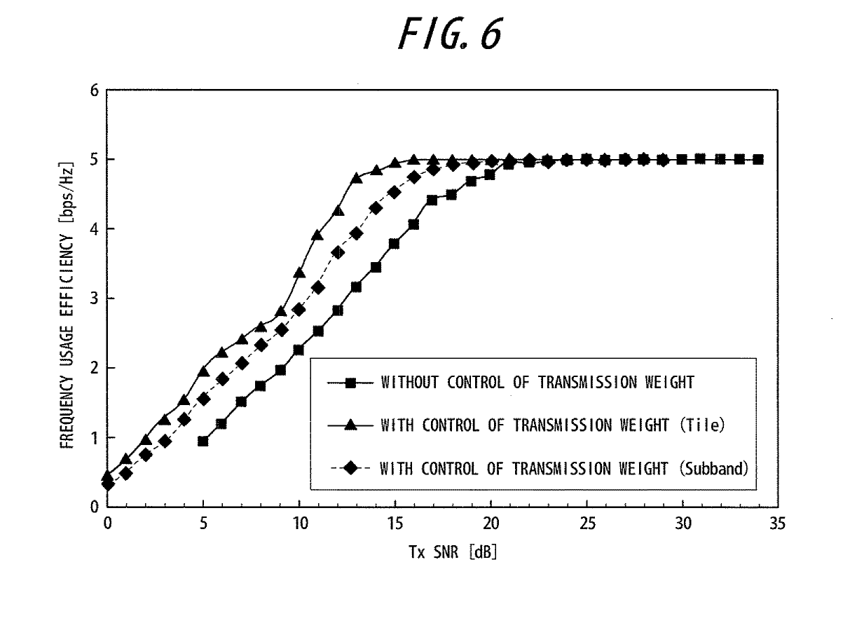

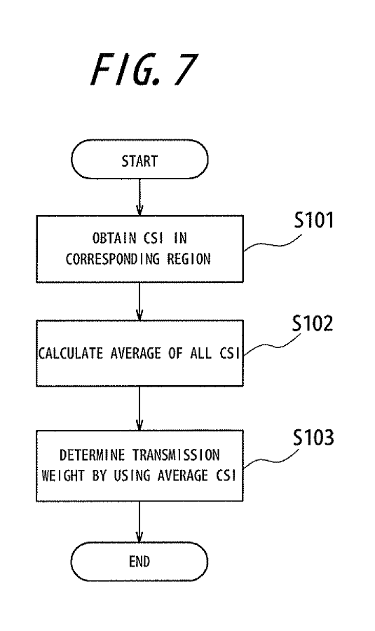

FIG. 4 is a flowchart of operation of the communication terminal according to one embodiment of the present invention. Operation of each block of the communication terminal 1 is described in detail with reference to the flowchart.

When the communication terminal 1 receives reference signals from the base station 2, the CSI calculation unit 20 of the communication terminal 1 obtains CSI of subcarriers in the transmission weight application range from the reception unit 10 (S001). According to the present embodiment, it is assumed that the transmission weight application range includes 128 subcarriers (N_{CSI}=128), for example. However, it is obvious for those skilled in the art that the number of subcarriers in the transmission weight application range is not limited to 128.

The CSI power calculation unit 21 of the CSI calculation unit 20 calculates power of CSI (Powₖ, 0≦k≦N_{CSI}) of each subcarrier in the transmission weight application range by using Formula 3 (S002).

$$\begin{matrix}{Pow}_{k} = {\vert {CSI}_{k} \vert}^{2} \\ = {[ \begin{matrix}{\vert \frac{{y}_{0 , 0}}{{x}_{0}} \vert}^{2} & {\vert \frac{{y}_{0 , 1}}{{x}_{1}} \vert}^{2} & … & {\vert \frac{{y}_{0 , TxAnt - 1}}{{x}_{TxAnt - 1} } \vert}^{2} \\ {\vert \frac{{y}_{1 , 0}}{{x}_{0}} \vert}^{2} & {\vert \frac{{y}_{1 , 1}}{{x}_{1}} \vert}^{2} & & {\vert \frac{{y}_{1 , TxAnt - 1}}{{x}_{TxAnt - 1}} \vert}^{2} \\ ⋮ & & ⋱ & ⋮ \\ {\vert \frac{{y}_{RxAnt - 1 , 0}}{{x}_{0}} \vert}^{2} & {\vert \frac{{y}_{Rxant - 1 , 1}}{{x}_{1}} \vert}^{2} & … & {\vert \frac{{y}_{RxAnt - 1 , TxAnt - 1}}{{x}_{TxAnt - 1}} \vert}^{2}\end{matrix} ]}_{k} \\ = {( {\sum }_{j = 0}^{TxAnt - 1} {\sum }_{i = 0}^{RxAnt - 1} {\vert \frac{{y}_{i , j}}{{x}_{j}} \vert}^{2} )}_{k}\end{matrix} \qquad [ Formula 3 ]$$

The CSI weighting processing unit 22 performs processing to multiply power (Powₖ), obtained by the CSI power calculation unit 21, by the CSI of each subcarrier for weighting (S003), In addition, the representative CSI calculation unit 23 calculates representative CSI (CSI_{w}_{_{—}}_{Ave}, representative channel state information) of the transmission weight application range overall after the processing by the CSI weighting processing unit 22, by obtaining the weighted average of subcarriers (S004). Formula 4 collectively shows calculations by the CSI weighting processing unit 22 and the representative CSI calculation unit 23.

$$\begin{matrix}{CSI}_{w \_ Ave} = \frac{1}{{\sum }_{k = 0}^{{N}_{Small \_ i \_ CSI} - 1} {Pow}_{k}} {\sum }_{k = 0}^{{N}_{Small \_ i \_ CSI} - 1} ( {Pow}_{k} \times {CSI}_{k} ) \\ = \frac{1}{{\sum }_{k = 0}^{{N}_{Small \_ i \_ CSI} - 1} {Pow}_{k}} \\ ( \begin{matrix}{\sum }_{k = 0}^{{N}_{Small \_ i \_ CSI} - 1} Re ( {Pow}_{k} \times {CSI}_{k} ) + \\ j {\sum }_{k = 0}^{{N}_{Small \_ i \_ CSI} - 1} Im ( {Pow}_{k} \times {CSI}_{k} )\end{matrix} )\end{matrix} \qquad [ Formula 4 ]$$

The transmission weight selection unit 30 selects the transmission weight based on the representative CSI (CSI_{w}_{_{—}}_{Ave}) provided from the representative CSI calculation unit 23 (S005). It is to be noted that, since a method to select a corresponding transmission weight from a certain CSI is known to those skilled in the art, a detailed description thereof is omitted. The transmission weight selection unit 30 stores a corresponding relation between the CSI and the transmission weight in advance and can select the transmission weight corresponding to the representative channel state information based on the corresponding relation. The transmission weight selection unit 30 feedbacks the transmission weight index, corresponding to the transmission weight selected, to the base station 2 via the transmission unit 40.

The base station 2 may improve the communication characteristics of the feedback MIMO by selecting the transmission weight by using such transmission weight index.

According to the present embodiment, the subcarrier with great power is reflected in the representative CSI, and a transmission weight corresponding to such subcarrier is selected. Therefore, it is possible to improve the communication characteristics of the feedback MIMO by reducing an influence by a subcarrier with limited channel capacity as a propagation path and deterioration of accuracy of the CSI caused by a phenomenon that phases are reversed and cancel each other. On the other hand, a corresponding transmission weight is not selected for a subcarrier originally having a poor channel capacity. However, data allocated in such a subcarrier can be recovered by an error correction scheme included in a system.

Although the present invention is described based on figures and embodiments, it is to be understood by those skilled in the art that many variations and modifications may be easily made based on disclosure of the present invention. Accordingly, such variations and modifications are included in a scope of the present invention.

Although the power is used as a standard for weighting of the CSI in the above embodiment, other standards such as a phase and amplitude are also applicable. For example, if the amplitude is used as the standard, the reception unit 10 detects the amplitude and the CSI weighting processing unit 22 uses the amplitude, in place of power, as a weighting coefficient, thereby the representative CSI calculation unit can calculate the representative CSI weighted according to the amplitude. In addition, although mere CSI between the antennas is described in the above embodiment, it is also possible to use a power level, as a system multiplying the CSI by the weight of transmission and reception, as the standard, for example.

In addition, although the wireless communication method is assumed as UMB in the above each embodiment, the scope of the present invention is not limited to such wireless communication method but applicable also to any wireless communication method such as LTE (Long Term Evolution), corresponding to the feedback MIMO. For example, as stated above, in UMB a frequency band used for communications is divided into 8 subbands and each subband is divided into 8 tiles, each of which is divided into 16 subcarriers. Similarly, in LTE the frequency band used for communications is divided into 9 subbands as necessary and, in such a case, each subband is divided into 2 to 6 resource blocks (RBs), each of which is divided into 12 subcarriers. Therefore, by reading the resource block of LTE in place of the tile of UMB in the above description as necessary, the description of each embodiment may be understood as embodiment employing LTE, It is to be understood that in such a case the number of subbands, resource blocks (tiles) and subcarriers are changed correspondingly to LTE.

### REFERENCE SIGNS LIST

1 communication terminal
2 base station
10 reception unit
20 CSI calculation unit
21 CSI power calculation unit
22 CSI weighting processing unit
23 representative CSI calculation unit
30 transmission weight selection unit
40 transmission unit

1. A wireless communication apparatus having a plurality of antennas comprising:
a reception unit for receiving signals of channels in a predetermined frequency band from another wireless communication apparatus and obtaining channel state information of the channels;
a channel state information calculation unit for calculating a weighted average of the channel state information as representative channel state information of the predetermined frequency band overall, based on power of the channel state information;
a transmission weight selection unit for selecting a transmission weight based on the representative channel state information; and
a transmission unit for transmitting identification information of the transmission weight to the another wireless communication apparatus.

2. A wireless communication apparatus having a plurality of antennas comprising:
a reception unit for receiving signals of channels in a predetermined frequency band from another wireless communication apparatus and obtaining channel state information of the channels;
a channel state information calculation unit for calculating a weighted average of the channel state information as representative channel state information of the predetermined frequency band overall, based on amplitude of the channel state information;
a transmission weight selection unit for selecting a transmission weight based on the representative channel state information; and
a transmission unit for transmitting identification information of the transmission weight to the another wireless communication apparatus.

3. The wireless communication apparatus according to claim 1, wherein the transmission weight selection unit stores a corresponding relation between the channel state information and the transmission weight and selects the transmission weight stored corresponding to the representative channel state information.

4. A wireless communication method of a wireless communication apparatus having a plurality of antennas comprising the steps of:
receiving signals of channels in a predetermined frequency band from another wireless communication apparatus and obtaining channel state information of the channels;
calculating a weighted average of the channel state information as representative channel state information of the predetermined frequency band overall, based on power of the channel state information;
selecting a transmission weight based on the representative channel state information; and
transmitting identification information of the transmission weight to the another wireless communication apparatus.

5. A wireless communication method of a wireless communication apparatus having a plurality of antennas, comprising the steps of:
receiving signals of channels in a predetermined frequency band from another wireless communication apparatus and obtaining channel state information of the channels;
calculating a weighted average of the channel state information as representative channel state information of the predetermined frequency band overall, based on amplitude of the channel state information;
selecting a transmission weight based on the representative channel state information; and
transmitting identification information of the transmission weight to the another wireless communication apparatus.

6. The wireless communication method according to claim 4, wherein at the step of selecting the transmission weight, the transmission weight corresponding to the representative channel state information is selected based on a corresponding relation between the channel state information and the transmission weight stored in advance.

7. The wireless communication apparatus according to claim 2, wherein the transmission weight selection unit stores a corresponding relation between the channel state information and the transmission weight and selects the transmission weight stored corresponding to the representative channel state information.

8. The wireless communication method according to claim 5, wherein at the step of selecting the transmission weight, the transmission weight corresponding to the representative channel state information is selected based on a corresponding relation between the channel state information and the transmission weight stored in advance.
